(19) United States
(12) Patent Application Publication
(10) Pub. No.: US 2023/0003391 A1
(43) Pub. Date: Jan. 5, 2023

(54) METHOD FOR OPERATING AN INDUCTION COOKTOP AND INDUCTION COOKTOP

(71) Applicant: E.G.O. Elektro-Geraetebau GmbH, Oberderdingen (DE)

(72) Inventors: Raphael Fricker, Pforzheim (DE); Steffen Weiss, Oberderdingen (DE)

(21) Appl. No.: 17/808,134

(22) Filed: Jun. 22, 2022

(30) Foreign Application Priority Data
Jul. 1, 2021 (DE) 10 2021 206 947.9

(51) Int. Cl. F24C 15/10; H05B 6/12; F24C 7/08

(52) U.S. Cl. CPC F24C 15/105; H05B 6/1209; F24C 7/083; F24C 7/087; H05B 2213/06; H05B 2213/05

(57) ABSTRACT

In order to detect on an induction cooktop whether a cooking vessel with an integrated controller or smart functionality is arranged over an induction heating coil, the induction heating coils emit a short individual code. The latter can be detected and evaluated by the cooking vessel such that the cooking vessel emits a signal corresponding to this code which is received by an external operating means or the induction cooktop to locally associate this cooking vessel with this induction heating coil. Transmission or transfer of energy as a code proceeds at a frequency of at least 50 kHz, wherein a code has a plurality of pulse sequences, each of which has at least two pulses.

### CROSS-REFERENCE TO RELATED APPLICATIONS

This application claims priority to German Application No. 10 2021 206 947.9, filed Jul. 1, 2021, the contents of which are hereby incorporated herein in its entirety by reference.

### FIELD OF APPLICATION AND PRIOR ART

The invention relates to a method for operating an induction cooktop, in particular with specially designed cooking vessels. The invention likewise relates to an induction cooktop designed to carry out the method.

DE 102004016631 A1 discloses an arrangement with which it is possible in relation to a cooktop to detect a cooking vessel being set down and the position thereof. on a heating means or a heating zone. A plurality of capacitively acting sensors are here provided in the outer zone of a heating means.

### PROBLEM AND SOLUTION

The problem addressed by the present invention is that of providing a method of the above-stated kind and an induction cooktop designed to carry out the method, with which prior art issues can be overcome and it is in particular possible to reliably detect and optionally display to an operator not only a cooking vessel being set down on or in a heating zone but also an identity of the cooking vessel.

This problem is solved by a method having the features of claim 1 and by an induction cooktop having the features of claim 20. Advantageous and preferred developments of the invention are the subject matter of the further claims and are explained in greater detail below. Some of the features are here described and explained only for the method or only for the induction cooktop. However, irrespectively, they are intended to apply separately and mutually independently both to the method and to induction cooktop. The wording of the claims is incorporated by express reference into the content of the description.

It is provided for the method for operating an induction cooktop with a plurality of induction heating coils that each induction heating coil have a heating zone. The latter is substantially formed by the area thereover which corresponds to the size of the induction heating coil. A cooking vessel can accordingly be arranged on the induction cooktop in such way that it overlaps with at least one heating zone, advantageously just one single heating zone of an induction heating coil. Each induction heating coil is designed to transfer energy for heating a cooking vessel in the heating zone, wherein it is driven in known manner by an inverter. Each cooking vessel has a transmit device with transmit antenna for transmitting a signal which is dependent on the received energy or on the type of energy transferred from an induction heating coil, the heating zone of which at least in part overlaps with the cooking vessel. This cooking vessel advantageously largely or completely overlaps with the heating zone.

A receive means is provided for receiving signals from a transmit device of a cooking vessel or all the transmit devices of cooking vessels on the induction cooktop. This receive means can be provided on the induction cooktop or alternatively or additionally on an external operating means or a mobile terminal.

A controller is provided which obtains the signals from the receive means and has or obtains the information for transmission or transfer of energy of the induction heating coils. Similarly to the receive means, this controller can be provided on the induction cooktop or alternatively or additionally on an external operating means or a mobile terminal. The receive means and controller are preferably arranged together or in the same unit.

The method has the following steps:

At least one cooking vessel is arranged over a heating zone of an induction heating coil, advantageously exactly one cooking vessel for exactly one detection process. This may proceed with the induction cooktop switched off or switched on and likewise with an already operating or heating induction cooktop. A plurality of induction heating coils, in particular all the induction heating coils, are driven for transmission or transfer of energy in a pattern, wherein duration and/or amplitude are here varied as a code. The code consists in that the amplitude of the transmitted or transferred energy varies within the code over time, in particular between zero and a maximum code value, and/or the duration of energy transfer varies, and/or the duration between two energy transfers varies, and/or the number of energy transfers varies. These possibilities may be used individually or also in combination, wherein this is also dependent on the number of codes required or the induction heating coils to be checked. Transmission or transfer of energy here proceeds as a code at a frequency of at least 50 kHz, preferably of at least 75 kHz to 150 kHz. A code here has at least one sequence of at least two pulses of energy, advantageously exactly three pulses or exactly four pulses, and thus forms a pulse sequence, such that a pulse sequence consists of at least two pulses. A code advantageously has at least two pulse sequences or sequences of pulses, advantageously exactly three or exactly four pulse sequences. Such a pulse of energy means a rapid rise and a rapid fall of energy within a short time or for a pulse duration. The advantage of using pulse sequences each having at least two pulses consists in that it is easier to control the energy drawn from an intermediate circuit of the induction heating coil drive circuit. Noise generation on the induction cooktop can moreover be reduced. An item of information or code about a specific induction heating coil can be encoded with various parameters such as pulse width, pulse duration, frequency, number of pulses or the like, in order to be able to shorten the time taken to uniquely establish the specific induction heating coil over which the cooking vessel is located. Each pulse sequence may accordingly in itself be sufficient to identify the induction heating coil. A duration of a pulse or the pulse duration within a pulse sequence may preferably be modified, for example on ramp-up of a PWM controller for the induction heating coil. Noise generation can in this way be reduced.

If a cooking vessel overlaps with a heating zone of an induction heating coil which has transferred energy with a specific or individual code, the transmit device of the cooking vessel transmits to the receive means a signal or a sequence of a plurality of signals, which are uniquely dependent on this received code and/or are associable with precisely this received code. The controller obtains the signals received by the receive means and compares them with information about the energy transmitted or transferred by the induction heating coils as codes which are known to the controller. In this way, it can establish which transferred energy code from a specific induction heating coil fits with a received signal or a sequence of a plurality of signals, wherein the signal has been received at the same point in time or shortly thereafter. On this basis, the controller can associate the cooking vessel transmitting this signal or this sequence of a plurality of signals with the heating zone or with the induction heating coil associated with the heating zone, since it is quite clear that the cooking vessel can only have received the signal-determining code from the induction heating coil arranged thereunder. In this way, the controller can determine that this cooking vessel overlaps with the heating zone of this induction heating coil. In the invention, it is also in principle alternatively possible for the transmitting induction heating coil also to be established or the association of the cooking vessel with the induction heating coil to be determined in the cooking vessel itself, for example in an integrated circuit or microcontroller of the cooking vessel. An item of information about it is then advantageously forwarded to the stated controller.

It is then possible, for example using a cooking program, as is also per se known, to drive this induction heating coil precisely for heating this cooking vessel. In an advantageous development, sensors can be arranged on the cooking vessel for monitoring a cooking process in the cooking vessel, and their data can then be correctly associated.

In an advantageous development of the invention, a cooking vessel has a receive coil in order to store an alternating magnetic field, which is used for transfer of energy, of an induction heating coil as electrical energy or to convert it into electrical energy. The signal can then be emitted by means of the transmit antenna of the transmit device. The energy required for this purpose may advantageously be the previously received or stored energy.

An energy storage means which is connected to the receive coil can be provided in the cooking vessel, wherein the energy received by the receive coil is stored in the energy storage means as previously described. A signal or a sequence of a plurality of signals can then be emitted by the transmit device with or corresponding to the stored energy. This advantageously contains the received code or contains the latter or the identifier thereof

The energy received by the receive coil can be used directly for electrically driving the transmit antenna for transmitting a signal or a sequence of a plurality of signals, which may be an alternative to the above-stated storage of the energy. The length and/or the strength of the at least one signal, in particular the sequence of a plurality of signals, may here correspond to the variance of duration and/or amplitude of the code. In this way, it is possible to transfer an item of information, for example the number or identifier of the particular induction heating coil, in the heating zone of which the cooking vessel is located and the code of which has thus been received.

It may here be provided that the transmit antenna transmits a signal as soon as energy is transferred to the receive coil from an induction heating coil, the heating zone of which overlaps with the cooking vessel or where the cooking vessel is arranged. The transmit device advantageously continues to transmit a signal for as long as energy is transferred or transmitted by the induction heating coil as a code to the receive coil. As soon as no energy is any longer being transferred from the induction heating coil to the receive coil, the transmit device also ceases to transmit a signal.

In a further development, the transmission or transfer of energy in the case of induction heating coils, for which it is unknown whether their heating zone is overlapped by a cooking vessel, can be frequently and/or regularly repeated to detect cooking vessels arranged in the heating zone thereof. This can in particular proceed at a frequency or refresh rate corresponding to a time interval of less than 1 min, preferably of less than 5 sec. In this way, the controller is very quickly informed as soon as such a cooking vessel has been arranged in the heating zone of an induction heating coil.

Advantageously, transmission or transfer of energy of the induction heating coils with a code can only proceed in the event that a cooking vessel with transmit device for detection of a code reports in on the induction cooktop or if an operator inputs this into a controller of the induction cooktop.

It may advantageously be provided that the transmission or transfer of energy of the induction heating coils with a code for detection of cooking vessels arranged in the heating zone also proceeds at least in the event that a change in the extent of overlap of a heating zone by a cooking vessel is detected. This means the case that the cooking vessel has been displaced, either far away or out of the heating zone, or only by a few cm; such a case can also be detected in this way.

A further development of the method may provide that the method is only carried out on a mobile terminal or an external control unit with controller and receive means when an app is active thereon or when the external control unit has been enabled. The actual above-stated cooking program using the specific cooking vessel can then be carried out on this mobile terminal or external control unit. If these are not active, the method also need not be carried out. Provision may be made for detection of switching on or coupling of the mobile terminal or of the external control unit with the induction cooktop to start the method automatically.

Provision may also be made for the method only to be carried out when a specific cooking vessel with the above-stated receive coil and with a transmit device has been discovered on the induction cooktop or in a heating zone. Further “pan detection sensors” may also be used for this purpose. As previously explained, the cooking vessel preferably also additionally has an integrated circuit and at least one sensor. The integrated circuit can evaluate the sensor and be used to transmit the information with the evaluation of the sensor, i.e. advantageously not just directly and solely the sensor signal, to a controller of the mobile terminal or external control unit or to a controller of the induction cooktop.

A code preferably consists of very brief power outputs, which are here denoted pulses, and oscillate or are generated at an operating frequency or the resonant frequency of an oscillator circuit with the induction heating coil. The pulses form the at least two pulse sequences. A pulse has or lasts as long as one or more oscillations and is thus formed by the oscillations. A total duration of a pulse is preferably between 0.1 μsec and 50 μsec, in particular between 10 μsec and 20 or 25 μsec, and is thus distinctly shorter and lower in energy than is the case during energy transfer for the actual heating.

Provision may advantageously be made for an interval between two pulses within a code to amount to a duration of a supply network half-wave or a multiple thereof, preferably an integral multiple thereof. The frequency of the supply network may amount to 50 Hz or 60 Hz, such that the interval may then amount to 10 msec or somewhat over 8 msec.

The transmit device can be selected from the group: Bluetooth, BLE, Zigbee, NFC, WiFi. Further transmit means are naturally possible, for example also with proprietary transmission protocols. Bluetooth and BLE are preferred due to the broad prevalence of their protocols, wherein BLE is particularly preferred due to its very low energy consumption.

As previously mentioned, the receive means and the controller may be arranged outside the induction cooktop, preferably in an external operating means. This external operating means then has operating elements and at least one display means. It may be a mobile terminal such as a smartphone or a tablet computer, but may also be a very specific external operating means for this induction cooktop. New functionalities can thus possibly be integrated into or enabled in the induction cooktop, which would otherwise only be possible, if at all, with costly replacement or retrofitting.

In addition to the receive coil and the transmit device, a cooking vessel preferably also has an integrated circuit so to speak as its smart functionality or intelligence. A certain degree of smart functionality can then also be provided in the transmit device so that it can appropriately process the signals to be transmitted. At least one further sensor, such as for example a temperature sensor or pressure sensor, is preferably also provided. A stated cooking program can thus be controlled or proceed in per se known manner because a state in the cooking vessel itself can be acquired with the sensor and taken into account. In addition, an above-stated energy storage means may also be a primary battery, secondary battery or capacitor. Alternatively, apart from a capacitor, no energy storage means may be provided in the cooking vessel, such that only energy for operating an integrated circuit and also the transmit device can be stored therein.

When all the induction heating coils are being driven for transfer of energy in order to detect cooking vessels arranged in the heating zone, energy can first of all be transferred for a short time as a pulse, wherein a pause is then provided, and then a plurality of different codes can be generated by way of a varying number of short sequences of energy transfers and pausing or by waiting for a specific multiple of a waiting time. The multiple of a waiting time may in particular be between 5% and 20% or 30% of the duration of the entire code. Each of the induction heating coils is here driven with a different code for transmission or transfer of energy with this code, wherein each induction heating coil is always recurrently driven with the same code. This code may preferably be permanently assigned to this induction heating coil.

The controller advantageously previously stores which cooking vessel is arranged in the heating zone of which induction heating coil. This is retained at least until something changes or until the controller and/or the induction cooktop are switched off. The controller detects cooking vessels newly arranged in a heating zone of an induction heating coil in the same way.

The controller preferably stores which cooking vessel is moved out of a heating zone, which the controller detects on the basis of changes in the operating parameters of the oscillator circuit with the induction heating coil, thus as it were at least by the induction heating coil itself, under certain circumstances also in addition by above-stated pan detection sensors.

In one development of the invention, transmission or transfer of a code is omitted for so long as, once an induction heating coil has detected and associated a cooking vessel with itself or with its heating zone, no change or movement of this cooking vessel in its said heating zone is registered. Such registration advantageously proceeds as stated above by detection of a change in the operating parameters of the oscillator circuit with the induction heating coil. A code is then preferably not transmitted again to this or to all the induction heating coils until a change or movement of the cooking vessel in its heating zone is registered, which can preferably be registered by an induction heating coil or indeed by other sensors.

It is preferably provided that all the induction heating coils simultaneously begin to transfer a code or transmit energy. In this way, the procedure can possibly be brought better in line with the other operation of the induction cooktop.

Each code advantageously first has a pulse or energy is briefly transferred for synchronization, this being denoted a “synchronization pulse”. This serves to synchronize the time sequence on all the cooking vessels and optionally to prepare them for shortly following further pulses or the code. From this synchronization pulse onwards, each induction heating coil can and should have a different code, so that it can be differentiated from the other induction heating coils, so that the cooking vessels can transmit different signals corresponding to the respective code.

It is advantageously provided that, after the synchronization pulse, at least two further pulses follow in a time interval within all the codes, wherein the number of subsequent pulses here preferably corresponds to a number of an individual induction heating coil or numbering of the induction heating coils plus 1. Within a code, the time interval between two pulses is particularly advantageously in each case identical until the final pulse before the next synchronization pulse.

It may alternatively be provided that a binary number is transferred by the code. Binary differentiation is achieved by in each case transmitting a pulse or no pulse at locations in a predetermined time grid, as is per se known from signal technology. Before the binary number is transferred, a pulse is preferably transmitted or energy briefly transferred for synchronization or as an above-stated synchronization pulse. This is here again important so that the individual pulses can be better detected.

Within all the codes, a time interval between two successive pulses may preferably be an integral multiple of an interval duration. The number of the integral multiples of the interval duration between two successive pulses corresponds to a number or numbering of the induction heating coils, wherein in particular each code only has exactly two pulses or exactly three pulses, in each case with the specific interval between one another.

An advantageous development of the invention may provide that all the codes have (n+1) pulses with (two to n) different interval durations. It is thus possible to differentiate n induction heating coils. The interval durations can then be evaluated with regard to their combination, which enables precise detection of the induction heating coil which has transmitted this code.

It is advantageously in principle provided that the signal sent by the transmit device is an already processed item of information, in particular this is directly the number of the induction heating coil as a designation or the position of the induction heating coil on the induction cooktop as at least two pulse sequences. This has been evaluated from a code received from an induction heating coil. The position of the induction heating coil on the induction cooktop can in particular be sent as x/y coordinates, based on the number of induction heating coils in the x direction and in the y direction, in order to locate an induction heating coil. Evaluation advantageously proceeds in the transmit device or in an integrated circuit of the cooking vessel, which is in turn particularly advantageously configured in or together with the transmit device. In the above-stated case of a transmit device with Bluetooth or BLE or Zigbee, an integrated circuit must in any event be provided. Alternatively, the code can be evaluated in the receive means or in the controller.

It is preferably provided that the method is only carried out on induction heating coils, the heating zone of which is in any way covered by a cooking vessel. Other induction heating coils may dispense with this method and only transmit or transfer individual pulses which are in any event necessary and also conventional for detecting the presence of cooking vessels, this even in the absence of a cooking vessel with a receive coil. The method can also only be carried out on those induction heating coils, the heating zone of which is overlapped by only exactly one cooking vessel.

In what are known as hotplate cooktops, it is possible for one cooking vessel to overlap with the heating zone of a plurality of induction heating coils. As a result, this cooking vessel receives the pulse pattern or pulse sequences of all the induction heating coils with the heating zones of which it overlaps. The cooking vessel must therefore possibly detect a plurality of pulse patterns from individual induction heating coils and extract what it can from a number of different superposed pulse patterns. Once such a case has been detected, the detecting induction heating coils can as a special case for once transmit their codes in succession.

The cooktop controller of a hotplate cooktop is normally capable of determining which induction heating coil is overlapped by which cooking vessel. Therefore, in the case of a cooking vessel which overlaps with a plurality of induction heating coils, the method may preferably in each case be carried out on only one induction heating coil, preferably only on the induction heating coil with the greatest degree of overlap.

It may furthermore be possible for one induction heating coil to be overlapped by a plurality of cooking vessels. It is preferably provided that the method is then only carried out on those induction heating coils, the heating zone of which is overlapped by just one cooking vessel. If a plurality are identified, the problem may arise that it is not possible to associate a code with exactly one single cooking vessel, since two cooking vessels arranged in the heating zone will receive the same code.

These and further features follow not only from the claims but also from the description and the drawings, wherein the individual features are realized in each case alone or several together in the form of a sub-combination in an embodiment of the invention and in other fields and may constitute advantageous, per se protectable embodiments, for which protection is here claimed. Subdivision of the application into individual sections and intermediate headings does not limit the general applicability of the statements made thereunder.

### BRIEF DESCRIPTION OF THE DRAWINGS

Further advantages and aspects of the invention are revealed by the claims and the following description of preferred exemplary embodiments of the invention, which are explained below with reference to the figures, in which:

FIG. 1 is a schematic representation of an induction cooktop according to the invention in an arrangement with a cooking vessel together with external operating unit placed on a heating zone of an induction heating coil,

FIG. 2 is a simplified representation of the functionalities of the smart cooking vessel,

FIGS. 3 to 11 show various codes.

### DETAILED DESCRIPTION OF THE EXEMPLARY EMBODIMENTS

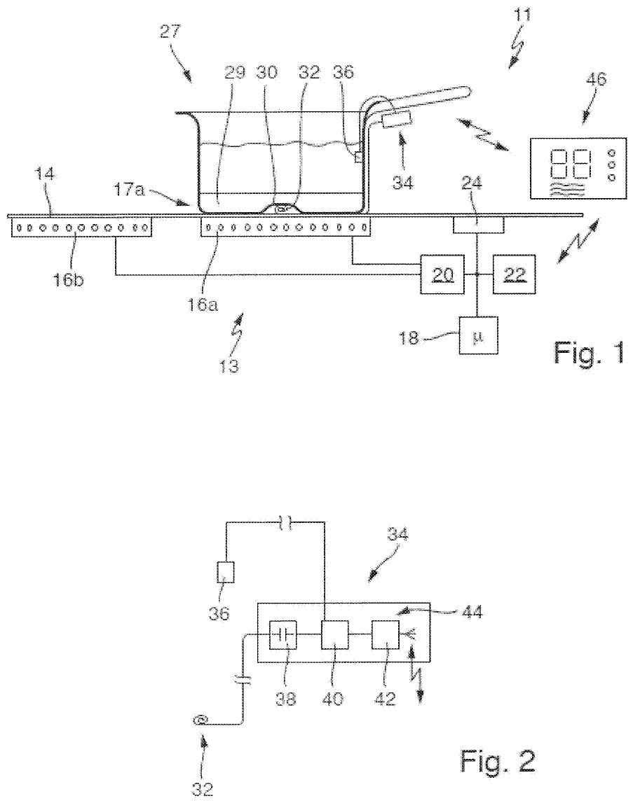

FIG. 1 shows is an arrangement 11 with an induction cooktop 13 according to the invention. The induction cooktop 13 has a cooktop plate 14 under which are arranged two induction heating coils 16a and 16b. In practice, there are advantageously more induction heating coils 16, for example four or six up to twenty or thirty in the above-stated hotplate cooktops.

The induction cooktop 13 furthermore has a cooktop controller 18 which is connected to functional units of an inverter device 20, a transmit/receive means 22 and an operating module 24 on the underside of the cooktop plate 14. These functional units are in each case of conventional design. A radio standard for the transmit/receive means 22 may in principle, as has been explained above, be of many and varied designs. It is advantageously selected from the above-stated options Bluetooth or BLE, but also Zigbee, WLAN or similar, and proprietary solutions without a generally applicable standard can be applied.

A heating zone is in each case formed above the induction heating coils 16a and 16b which has an area approximately corresponding to the area of the induction heating coils 16. A cooking vessel 27 is arranged in the heating zone 17a or has been set down there on the top of the cooktop plate 14. The cooking vessel 27 has a receive coil 32 in a recess 30 in its bottom 29. The receive coil 32 has few turns and is arranged on the underside of the bottom 29 in such a way that it lies exposed or is not shielded by the rest of the bottom from the magnetic field of the induction heating coil 16a. This is important for the previously described energy transfer. The receive coil 32 is connected to a cooking vessel module 34 which is shown in magnified view in FIG. 2.

An external operating means 46 is shown on the right in FIG. 1 which may on the one hand be a specific operating means for the induction cooktop 13 or alternatively a mobile terminal such as a tablet computer or a smartphone. The external operating means 46 has a large-area display, as is shown. It furthermore has, as is in particular known for the stated mobile terminals, a receive means, a transmit means and also a processor or integrated circuit. A radio standard here matches the transmit/receive means 22, thus advantageously Bluetooth or BLE. There is no need to say much about the external operating means 46; a cooking program of the kind explained above can run on it for example by means of an app or a specific program. The external operating unit is not absolutely necessary. Its functionality can likewise be integrated in an operating and control unit located within the cooktop.

FIG. 2 shows a magnified view of the cooking vessel module 34. The cooking vessel module 34 is connected to the receive coil 32 by means of an electrical connection in the form of a cable or the like. The cooking vessel 34 is electrically conductively connected in a similar manner to a temperature sensor 36, which is arranged outside thereof. and according to FIG. 1 is advantageously arranged in the interior of the cooking vessel 27, such that it is surrounded by the water or food being cooked therein and is capable of determining the temperature thereof. This temperature sensor can likewise be set into the bottom of the cooking vessel if the intention is to acquire not the temperature of the food being cooked but the temperature of the bottom. Instead of the temperature sensor 36, still further sensors such as pressure sensors, weight sensors or the like are alternatively or additionally conceivable.

The cooking vessel module 34 furthermore has an energy storage means 38 which is directly connected to the receive coil 32. This may be a secondary battery, advantageously it is an above-stated capacitor, since it does not to have to store a particularly large amount of energy, especially if Bluetooth or BLE or Zigbee is used for transmission, but is intended to do so in as quick and loss-free manner as possible.

An integrated circuit 40 is provided as a kind of controller in the cooking vessel module 34 which acquires the energy or the signals or pulses received by the receive coil 32, advantageously with regard to duration and/or interval and/or amplitude or also added energy stored in the energy storage means 38. The integrated circuit 40 drives a transmit device 42 with transmit antenna 44, advantageously constructed with the above-stated Bluetooth or BLE standard or Zigbee.

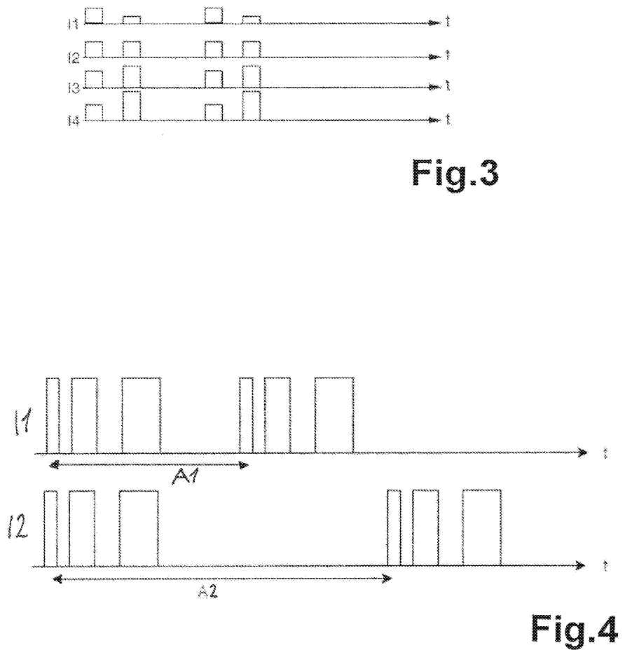

FIG. 3 shows one possible way in which, in the case of four induction heating coils I1 to I4, it is possible to create differentiation in each case after a synchronization pulse transmitted simultaneously to all induction heating coils by way of an amplitude of a subsequently transmitted pulse. The amplitude here increases incrementally with the higher number of the induction heating coil. The pulses with differing amplitude are here simultaneously transmitted, but can of course also be transmitted in time-offset manner. Each pulse sequence thus in this case too also has at least two pulses.

FIG. 4 shows, by way of example for two induction heating coils, a respective code over time t, above for the first induction heating coil I1 and below for the induction heating coil I2. The pulse sequences are in themselves indeed identical, three pulses with a respective pulse duration being in each case provided, wherein the pulse duration of the second pulse is twice as long as the first pulse and the third pulse three times as long as the first pulse. A pause as a time interval between the individual pulses of each pulse sequence also varies, the second pause between the second pulse and the third pulse being twice as long as the first pause between the first pulse and the second pulse. The pulse sequences are accordingly very characteristically and uniquely detectable. These pulse sequences are used for the two induction heating coils shown here, but are advantageously used for all the induction heating coils of the induction cooktop. These two pulse sequences are thus varied in order to establish over which induction heating coil a cooking vessel has been placed.

The time is here measured between two pulse sequences including ramp-up of the pulse sequence, in order to reduce the noise generated in the induction cooktop. Ramp-up should here be taken to mean incrementing a duty factor in power generation for the induction heating coil and/or as reducing the frequency within a short time. Energy transfer and the frequency spectrum of the pulse or pulses is accordingly controlled. FIG. 4 shows the duty factor, but the frequency also varies. In the case of induction heating coil I1, the time interval between the two identical pulse sequences amounts to A1 while in the case of induction heating coil I2, it amounts to A2 and is distinctly longer. For a further induction heating coil, the time interval Ax would then be still longer than A2.

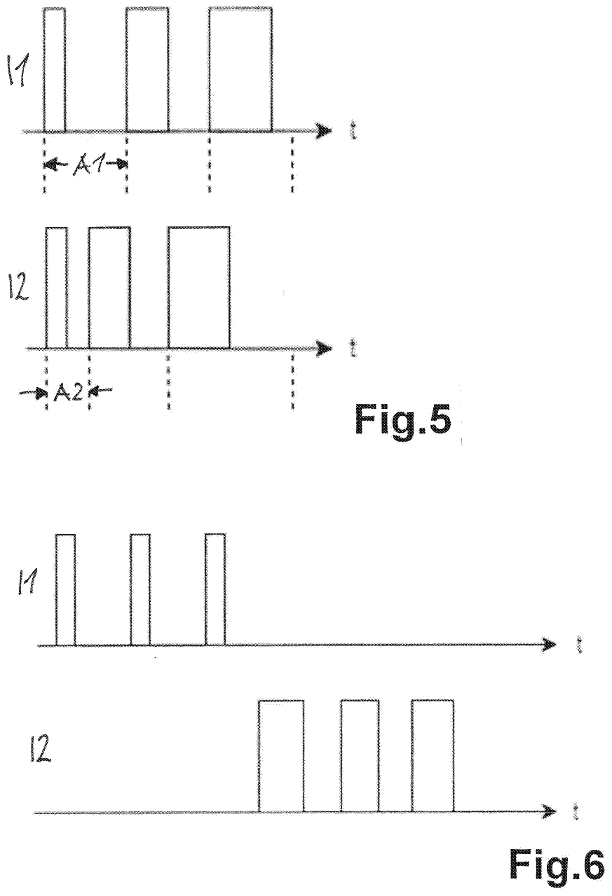

FIG. 5 again shows two pulse sequences for an induction heating coil I1 and an induction heating coil I2. These pulse sequences shown in detail can, as in FIG. 4, in each case be used at least twice. This is, however, not mandatory. The second pulse sequence for induction heating coil I2 exactly corresponds to that from FIG. 4. In the first pulse sequence above for induction heating coil I1, the time interval A1 between the first pulse and the second pulse is exactly twice as long as the time interval A2 in the lower pulse sequence. As still another variation, the time interval between the second pulse and the third pulse could additionally or alternatively also be varied.

The various methods can accordingly be shown for the above-stated ramp-up, wherein only one parameter is modified. In the upper pulse sequence, the duty factor is incremented after each pulse sequence or period, wherein the frequency remains constant. In the lower pulse sequence, a fixed duty factor, for example 50%, is used, wherein the frequency is adapted after each pulse sequence or period. In this example, the frequency is reduced after an elevated starting frequency, wherein the frequency is then approximated to the resonant frequency.

FIG. 6 makes use of three short pulses as a simpler variation for induction heating coil I1 above, and a pulse sequence of three pulses which are more than twice as long for induction heating coil I2 below, wherein the time intervals between the individual longer pulses are shorter. Overall, however, the lower pulse sequence lasts somewhat longer than the upper pulse sequence. Another pulse sequence is thus used above for induction heating coil I1 than for induction heating coil I2, for example with the meaning of a duty factor of 25% in the upper pulse sequence and 50% in the lower pulse sequence, in each case at identical frequency.

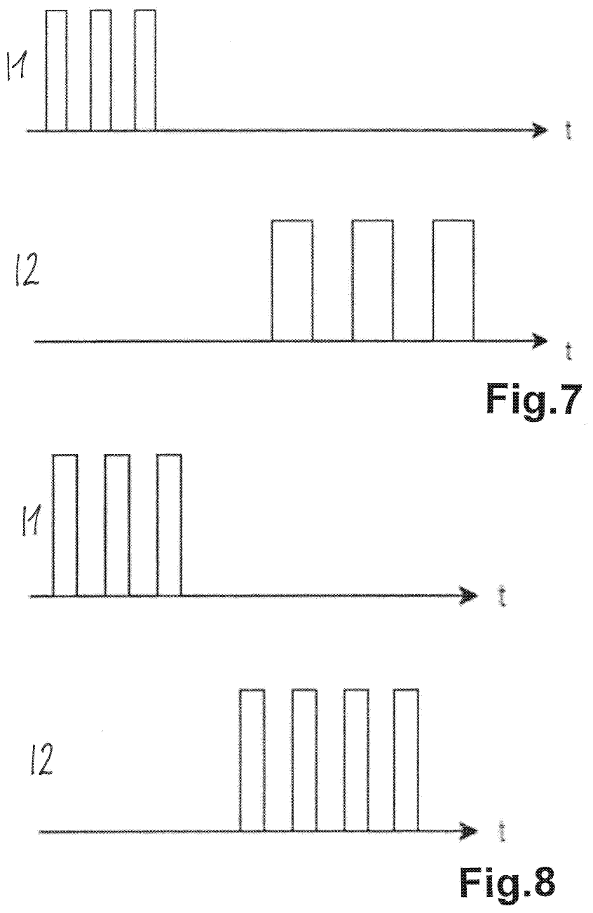

In FIG. 7, the pulse duration and time interval between the pulses in each pulse sequence are varied. A frequency of 70 kHz can accordingly be used above for induction heating coil I1 and a frequency of 60 kHz below for induction heating coil I2, wherein the same duty factor overall is used above and below. The two pulse sequences above and below can have a time offset from one another, as is shown here. This need not be the case, however, and they can also be started simultaneously.

In FIG. 8, the pulse count of the two pulse sequences is varied. Three short pulses with a short time interval between one another are used for the upper induction heating coil I1. Four short pulses with a short time interval between one another are used for the lower induction heating coil I2, wherein the pulse duration and time interval between one another corresponds to the upper pulse sequence. The duty factor and frequency may here advantageously remain identical.

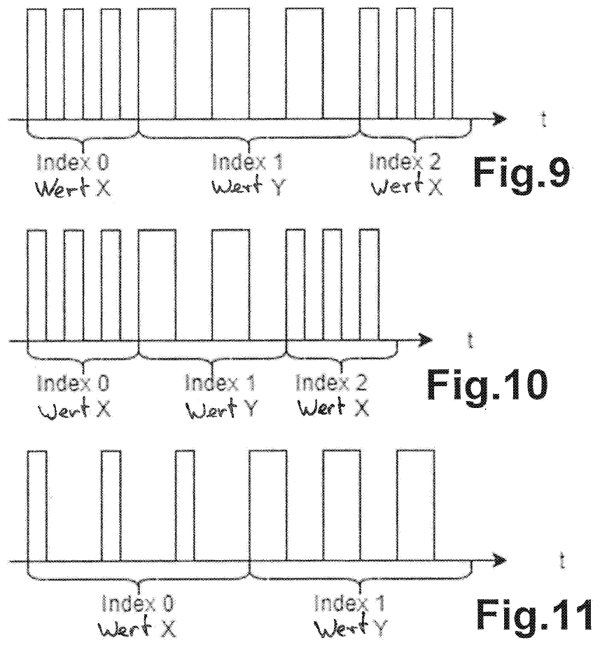

In the exemplary embodiments of FIGS. 9 to 11, the parameters within a pulse sequence are varied in order to code a position of the induction heating coil in an above-stated coordinate system of the induction heating coil within the induction cooktop. The information can be encoded either by means of frequency at an identical duty factor, see FIGS. 9 and 10, or by means of the duty factor at an identical frequency, see FIG. 11.

The value x or y as an index for determining an arrangement in the coordinate system can accordingly be derived from the signal. It should be noted here that whole pulses are always output, wherein it is, however, possible to adapt the number depending on the frequency. Accordingly in FIG. 9 the index 1 corresponding to the value y has 3 pulses, and in FIG. 10 it has only 2 pulses. As a function of the duty factor, the value x or y may represent a plurality of bits, depending on the number of frequencies used. The number of transferred indices, which may be a plurality of bits, may be modified as a function of data to be transferred and the duty factor. In FIGS. 9 and 10 there are accordingly in each case 3 indices and in FIG. 11 there are only 2 indices. It should be noted here that a duty factor of 0% can also be selected for the second value, the value y in the example here, whereby amplitude shift keying, i.e. a digital type of modulation, is achieved. The amplitude of the carrier is here modified in order to transfer different values.

1. A method for operating an induction cooktop having a plurality of induction heating coils, wherein:
each said induction heating coil has a heating zone,
a cooking vessel can be arranged to overlap with at least one said heating zone,
each said induction heating coil is designed for transmission or transfer of energy in order to heat one said cooking vessel, wherein an inverter is provided to drive each said induction heating coil,
each said cooking vessel has a transmit device with a transmit antenna for transmitting a signal as a function of energy received from one said induction heating coil, a heating zone of said induction heating coil at least in part overlaps with said cooking vessel,
a receive means is provided for receiving signals from a transmit device of one said cooking vessel or all said transmit devices of said cooking vessels on said induction cooktop,
a controller is provided which obtains said signals from said receive means and has information for transmission or transfer of energy of said induction heating coils or obtains said information,
wherein said method has the following steps:
at least one said cooking vessel is arranged over one said heating zone of one said induction heating coil,
a plurality of said induction heating coils are driven for transmission or transfer of energy in a pattern, wherein duration and/or amplitude are varied as a code, wherein said code consists in that
an amplitude of said transmitted or transferred energy within said code varies over time, and/or
a duration of energy transfer varies, and/or
a duration between two said energy transfers varies, and/or
a number of said energy transfers varies,
wherein transmission or transfer of said energy proceeds as a code at a frequency of at least 50 kHz,
wherein one said code has at least one sequence of at least two pulses and forms a pulse sequence,
if one said cooking vessel overlaps with one said heating zone of one said induction heating coil which has transferred energy with a specific code, said transmit device transmits to said receive means a signal or a sequence of a plurality of signals, which are uniquely dependent on said code and/or are associable with precisely said code,
said controller obtains said signals received by said receive means and compares said signals with information about said energy transmitted or transferred by said induction heating coils as said codes, in order to establish which said transferred energy code from a specific induction heating coil fits with a received signal or a sequence of a plurality of signals, in order on said basis to associate said cooking vessel transmitting said signal or said sequence of a plurality of said signals with said heating zone or with said induction heating coil associated with said heating zone.

2. The method as claimed in claim 1, wherein one said cooking vessel has a receive coil in order to store an alternating magnetic field of an induction heating coil as electrical energy in order to emit the signal by means of the transmit antenna of the transmit device, wherein said magnetic field is used for said transfer of said energy.

3. The method as claimed in claim 1, wherein an energy storage means which is connected to said receive coil is provided in said cooking vessel, wherein said energy received by said receive coil is stored in said energy storage means and wherein a signal or a sequence of a plurality of signals is emitted by said transmit device corresponding to said stored energy.

4. The method as claimed in claim 1, wherein said transmission or said transfer of said energy in the case of said induction heating coils, for which it is unknown that or whether their heating zone is overlapped by one said cooking vessel, is frequently and/or regularly repeated to detect said cooking vessels arranged in said heating zone.

5. The method as claimed in claim 4, wherein said transmission or said transfer of said energy in the case of said induction heating coils is frequently and/or regularly repeated at a frequency or a time interval of less than 5 sec.

6. The method as claimed in claim 1, wherein said transmission or said transfer of said energy of said induction heating coils for detection of said cooking vessels arranged in said heating zone also proceeds at least in an event that a change in an extent of overlap of one said heating zone by one said cooking vessel is detected.

7. The method as claimed in claim 2, wherein said method is only carried out when one said cooking vessel with said receive coil and with one said transmit device has been discovered on said induction cooktop, wherein said cooking vessel also additionally has an integrated circuit and at least one sensor.

8. The method as claimed in claim 1, wherein one said code consists of pulses, of which at least two said pulses form said at least one pulse sequence, wherein said pulses are generated at an operating frequency or said resonant frequency of an oscillator circuit with said induction heating coil, wherein one said pulse has one or more oscillations.

9. The method as claimed in claim 8, wherein said pulse has one or more oscillations with a total duration of between 0.1 μsec and 50 μsec.

10. The method as claimed in claim 1, wherein, when all said induction heating coils are being driven for transfer of energy in order to detect said cooking vessels arranged in said heating zone, said energy is first of all transferred for a short time as a pulse, a pause is then provided, and then a plurality of different codes is generated by way of a varying number of short sequences energy transfers and pausing or by waiting for a specific multiple of a waiting time, and each of said induction heating coils is driven with a different code, but each said induction heating coil always recurrently with the same code, for transmission or transfer of energy with said code.

11. The method as claimed in claim 10, wherein said waiting time is between 5% and 20% of a duration of said codes.

12. The method as claimed in claim 1, wherein said controller stores which one said cooking vessel is arranged in said heating zone of which induction heating coil, wherein said controller detects cooking vessels newly arranged in a heating zone of one said induction heating coil in the same way.

13. The method as claimed in claim 1, wherein transmission or transfer of one said code is omitted for so long as, once one said induction heating coil has detected and associated one said cooking vessel, no change or movement of said cooking vessel in its heating zone is registered by a change in said operating parameters of said oscillator circuit with said induction heating coil, wherein a code is then not transmitted again to said or to all said induction heating coils until a change or movement of said cooking vessel in its heating zone is registered by one said induction heating coil or by other sensors.

14. The method as claimed in claim 1, wherein all said induction heating coils simultaneously begin to transfer a code as said transmission of energy.

15. The method as claimed in claim 1, wherein each said code first has a pulse or energy is briefly transferred for synchronization and, from said synchronization pulse onwards, each said induction heating coil has a different code.

16. The method as claimed in claim 15, wherein, after said synchronization pulse, at least two further pulses follow in a time interval within all said codes and a number of following pulses corresponds to a numbering of said induction heating coils.

17. The method as claimed in claim 16, wherein within a code said time interval is in each case identical until a final pulse before said next synchronization pulse.

18. The method as claimed in claim 1, wherein said transmit device sends a processed item off information or directly a number of said induction heating coil as a designation or a position of said induction heating coil on said induction cooktop as at least two pulse sequences, which has been evaluated from said code received from one said induction heating coil.

19. The method as claimed in claim 18, wherein said evaluation proceeds in said transmit device, wherein said position of said induction heating coil on said induction cooktop is sent as x/y coordinates.

20. An induction cooktop for carrying out the method as claimed in claim 1, wherein said induction cooktop has a plurality of said induction heating coils, wherein at least one said heating zone is associated with each said induction heating coil.
